(19) United States
(12) Patent Application Publication
(10) Pub. No.: US 2012/0145771 A1
(43) Pub. Date: Jun. 14, 2012

(54) DEVICE AND METHOD FOR AUTOMATIC MULTIPLE-BEAD WELDING

(75) Inventor: Gunnar Bohlin, Gardsjo (SE)

(73) Assignee: ESAB AB, Goteborg (SE)

(21) Appl. No.: 13/390,568

(22) PCT Filed: Aug. 20, 2010
(86) PCT No.: PCT/SE2010/050900

§ 371 Date: Feb. 15, 2012

(30) Foreign Application Priority Data
Aug. 24, 2009 (SE) 0950604-9

(51) Int. Cl. B23K 31/02; B23K 37/00

(52) U.S. Cl. 228/102; 228/9

(57) ABSTRACT

A welding device and a method for automatic multiple-bead welding, wherein a line illumination member is arranged to illuminate the joint by scanning a light beam across the joint line. A camera is arranged for the registration of line images of the joint when it is illuminated with the scanned light beam. The locations of the edges of the joint are determined by means of triangulation based on the registered line image. The welding device can include a stereo image member arranged to register photometric stereo images of the joint substantially simultaneously with the registration of the line images. The welding device is arranged to, during welding of a weld joint with a plurality of weld beads, control the welding head in dependence on both stereo images and line images.

### TECHNICAL FIELD

The present invention concerns automatic welding. More specifically, the present invention concerns a method and a device for automatic multiple-bead welding. The automatic multiple-bead welding comprises joint tracking.

### BACKGROUND

When welding sheets, the sheets are joined by applying melted metal in the joint between the sheets. The melted metal is called weld bead and may originate from the sheets or from material that has been supplied from a welding wire. For a plurality of products it is necessary to use thick sheets. Examples of such products are ships, pipelines and towers for wind power plants. When welding thick sheets it is not possible to obtain a strong weld by only welding one single weld bead. In order to obtain a strong weld joint several weld beads are required which are applied in the joint between the sheets. In order for the weld joint to be strong it is required that the successive weld beads are applied upon each other so that they fill out the whole joint between the sheets. Towers for wind power plants, as mentioned as an example above, are normally welded together from tube sections. The tube sections usually have a length of some meter. When two such tube sections are to be welded together, the tube sections are arranged next to each other in a rotation cradle such that their longitudinal axes essentially coincide. The tube sections can rotate around its longitudinal axis in the rotation cradle. A welding head is arranged at the joint between the tube sections. During welding, the tube sections are rotated around their longitudinal axes while the welding head is held substantially fixed. The tube sections do however not have end surfaces which are completely plane and perpendicular to the longitudinal axis and are also not completely cylinder shaped. This has as a consequence that the welding head must be moved radially and axially in relation to the longitudinal axes of the tube sections in order for the weld beads to be correctly positioned. A plurality of known techniques for controlling a welding head along a joint exists.

In the Swedish patent 515 773 a method is described for joint tracking in which a laser scanner is used for detecting the geometry of the joint. The laser scanner uses laser triangulation in order to detect the edges and the sides of the joint. The electrode feeding speed, the welding speed and the position of the electrode and the number of beads are automatically adjusted such that the end result will be as desired even if there are deviations in the joint geometry or the joint volume. The method requires that the geometry of the joint is determined before each new weld bead. When the weld bead is being filled, it becomes however more and more difficult to determine the edges of the joint.

The American U.S. Pat. No. 5,302,799 describes a welding analysing system and a control system which is intended for automatic welding devices. The control system uses an optical stereo guiding system which is described in the American U.S. Pat. No. 5,111,126. The stereo guiding system comprises mirrors which ensure that two separate images will reach the camera.

The American U.S. Pat. No. 5,572,102 describes a method and a device for controlling welding robots and is based on registering a reference image of a weld on a reference workpiece. The reference image is used when welding another workpiece in that the image of the other workpiece is compared with the reference image. The welding is then controlled on the basis of the comparison. With the method corrections in real time of the weld path are avoided.

### SUMMARY OF THE INVENTION

An object of the present invention is to provide a method and a device that enable a robust joint tracking.

A further object of the present invention is to provide a method and a device which enable joint tracking even when the weld joint is being filled.

According to a first aspect of the present invention a welding device is provided for automatic multiple-bead welding of a joint that is formed by two joint surfaces, which joint extends along a joint line and which comprises a first edge on one side of the joint line and a second edge on the other side of the joint line, which edges define the extension of the joint across the joint line. The welding device comprises a welding head for the application of weld beads in the joint, a line illumination member which is arranged to illuminate the joint by scanning a light beam across the joint line, at least one camera arranged for registering line images of the joint when it is illuminated with the scanned light beam, and a processing member for determining at least the location of the edges of the joint by means of triangulation based on the registered line image. The welding device is characterized in that it comprises a stereo image member arranged to register photometric stereo images of the joint substantially simultaneously with the registration of the line images, wherein the welding device is arranged to during welding of a weld joint with a plurality of weld beads control the welding head in dependence on both stereo images and line images.

The determination of the location of the edges of a joint by triangulation is a well known method within welding and will not be described more closely here. However, it is difficult to use triangulation in order to find the edges of a weld joint when the joint is almost filled with weld beads. By registering photometric stereo images it is possible to more accurately determine the edges of the weld joint when the weld joint is almost filled. However, triangulation is a faster method, which means that one wants to use it as long as it is possible. By photometric stereo images is meant images which have different information about the same area. Different information may for example be obtained by taking images of the same area from different angles. In accordance with the invention it is possible to use more than two different images in a stereo image.

The welding head is controlled such that the weld bead will land correctly in the weld joint. In order for it to be possible to achieve this, it is necessary to know the position of the welding head in relation to the camera.

The stereo image member may comprise a first illumination member and a second illumination member, wherein the first illumination member is arranged to illuminate the joint from one side of the joint line and the second illumination member is arranged to illuminate the joint from the other side of the joint line, and wherein the welding device is arranged to with said at least one camera register a first stereo image when the joint is illuminated with the first illumination member and a second image when the joint is illuminated with the second illumination member. The stereo images are put together to a photometric stereo image which is used for determining the locations of the edges of the joint. It is possible to use more than two light sources and/or more than two stereo images. It is for example possible to take one image without any of the illumination members being illuminated.

The first and the second illumination members are with advantage arranged such that they substantially illuminate along one illumination direction each, wherein the angle between the illumination directions for the first and second illumination member is greater than 90°. Such an arrangement of the illumination directions gives a good contrast in a composite image, which has as a consequence that the location of the edges can be determined with a high certainty.

The camera which is arranged to register stereo images may also be arranged for registering line images. By only having one camera, the arrangement of the camera in relation to the welding head is facilitated. Furthermore, the cost for the welding device is lower with only one camera compared with the case that it would have two cameras or more.

The welding device comprises position determination members for determining the positions for the registration of the stereo images and the line images, wherein the stereo images are stored in the processing member together with the position for their registration. In this manner, it is possible, when determining the location of the edges before the application of a weld bead, to use the images which were registered when the previous weld bead was applied.

The processing member may be arranged to, when registering a stereo image in a position where a stereo image previously has been registered, correlate the registered stereo image with the previously stored stereo image for the position in order to obtain a displacement value which describes how much the joint has been moved across the joint line in relation to the previously stored image. The displacement value can be used for controlling the welding head.

The processing member may be arranged to, when registering a line image in a position, in which a line image has been registered previously, replace the previously stored locations of the edges of the joint by locations which are determined from the registered line image if such a determination is possible and to otherwise add the displacement value to the previously stored locations of the edges of the joint. The use of the displacement value in the mentioned manner is done when a plurality of weld beads already have been applied in the weld joint and the triangulation does no longer give any reliable information of the locations of the edges.

The processing member may be arranged to use information of where the previous weld bead was applied at the correlation of the registered stereo image with the previously stored stereo image. This may give further security when controlling the welding head such that the weld bead lands at the correct location.

The line illumination member may be designed in many different manners, but according to a preferred embodiment it comprises a laser. The laser is with advantage a diode laser. With a laser as light source it is possible to obtain a well defined beam on the weld joint. Diode lasers are relatively inexpensive which makes it possible for the price for the welding device to be low.

Said at least one camera is with advantage provided with an interference filter which is arranged for transmission of the light from the first illumination member and the second illumination member. With an interference filter undesired light is filtered out. This has a consequence that the photometric stereo image becomes more sharp.

According to a second aspect of the invention, a method is provided for controlling multiple-bead welding of a joint formed by two joint surfaces, which joint extends along a joint line and which comprises a first edge on one side of the joint line and a second edge on the other side of the joint line, which edges define the extension of the joint across the joint line. The method comprises the steps to illuminate the joint with a light beam by scanning the light beam across the joint line, to register a line image of the joint at a plurality of positions along the joint line when it is illuminated with the scanned light beam, and to determine at least the location of the edges of the joint by means of triangulation based on the registered line image. The method is characterized in that it also comprises the steps to register photometric stereo images of the joint at said plurality of positions along the joint line substantially simultaneously with the registration of the line images with the scanned light beam, to during welding of a weld joint with a plurality of weld beads control the welding head in dependence on both stereo images and said data for the shape of the joint.

With a method according to the second aspect of the invention, the same advantages as described in connection with the first aspect of the present invention are achieved.

The method also comprises the steps to determine the positions for the registration of the stereo images and the line images, and to store the stereo images and said locations of the edges of the joint in the processing member together with the position for their registration. In this manner it is possible, when determining the location of the edges before the application of a weld bead, to use the images which were registered at the application of the previous weld bead.

When registering a stereo image in a position where a stereo image previously has been registered, the registered stereo image may be correlated with the previously stored stereo image for the position in order to obtain a displacement value which describes how much the joint has been moved across the joint line in relation to the previously stored stereo image. The displacement value may be used for controlling the welding head.

When registering a line image in a position, in which a line image has been registered previously, the previously stored locations of the edges of the joint may be replaced with locations which are determined from the registered line image if such a determination is possible and to otherwise add the displacement value to the previously stored positions. The use of the displacement value in the mentioned manner is done when a plurality of weld beads already have been applied in the weld joint and the triangulation no longer gives any reliable information about the locations of the edges.

Information about where the previous weld bead was applied may be used at the correlation of a registered stereo image with a previously stored stereo image. This may give further security when controlling the welding head such that the weld bead lands on the correct location.

### SHORT DESCRIPTION OF THE DRAWINGS

FIG. 1 shows schematically a welding device and two tubes when the tubes are being welded together.

FIG. 2 shows in more detail the welding device and the members for registering images.

FIG. 3 is a flow chart which describes the method according to the present invention.

### DETAILED DESCRIPTION

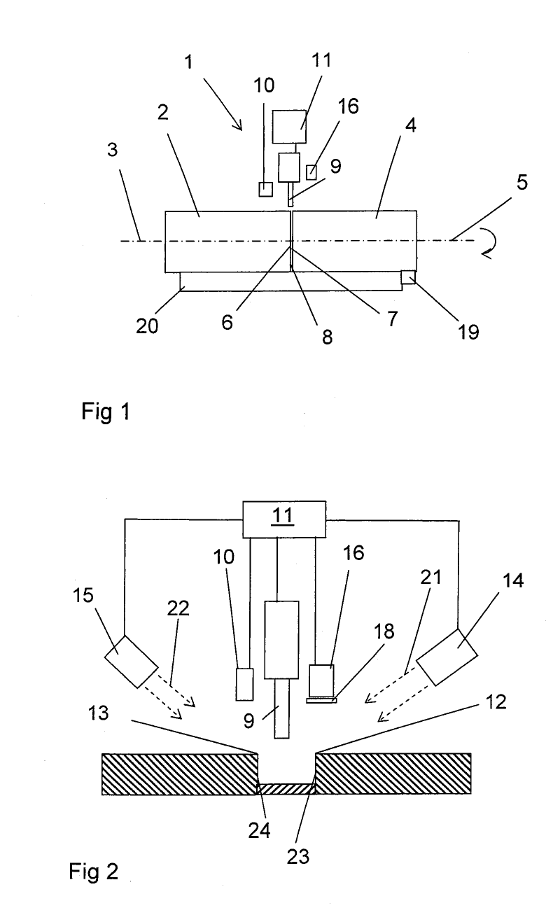

FIG. 1 shows schematically a welding device 1 for automatic multiple-bead welding of a joint formed by two joint surfaces 23, 24. FIG. 1 shows a first tube 2 with a symmetry axis 3, and a second tube 4 with a symmetry axis 5, wherein the first tube 2 has substantially the same diameter as the second tube 4. The tubes are arranged in a cradle 20, with the first end 6 of the first tube 2 next to the first end 7 of the second tube 4, and with the symmetry axes arranged such that they substantially coincide with each other. The junction between the tubes 2, 4 defines a joint line 8. The tubes 2, 3 can be rotated around their symmetry axes in the cradle 20. The welding device 1 comprises a welding head 9 for the application of weld beads in the joint in order to weld the tubes together, and a line illumination member 10 which is arranged to illuminate the joint by scanning a light beam across the joint line 8. According to an embodiment of the invention, the line illumination member comprises a laser such as for example a diode laser. It is of course possible to use other kinds of lasers and other kinds of light sources. The welding device 1 also comprises a camera 16 arranged for registering an image of the joint when it is illuminated with the scanned light beam. Such an image will in the following be called line image. The welding device also comprises a processing member in the form of a computer 11, for determining the location of the edges of the joint by means of triangulation based on the registered line image. Triangulation is a well known method for determining the locations of the edges in a weld joint and will therefore not be described in detail here.

The welding device 1 also comprises a stereo image member arranged to register photometric stereo images of the joint substantially simultaneously with the registration of the line images. The stereo image member will be described in more detail below in connection with the description of FIG. 2. The welding device 1 also comprises a position determination member for determining the positions for the registration of the stereo images and the triangulation image. The position determination member may comprise an angle indicator 19 which is connected to the cradle 20 in order to measure the rotation of the tubes 2, 4. The stereo images are stored in the computer together with the position for their registration which has been registered with the angle indicator 19. The welding device 1 controls the welding head 9 in dependence on both stereo images and said positions of the edges of the joint.

FIG. 2 shows in more detail the welding device and the members for registering images. In FIG. 2 also the joint is shown in more detail. The joint comprises a first edge 12 on one side of the joint line 8 and second edge 13 on the other side of the joint line 8. The edges 12, 13 define the extension of the joint across the joint line 8. The stereo image member comprises a first illumination member 14 and a second illumination member 15, wherein the first illumination member 14 is arranged to illuminate the joint from one side of the joint line 8 and the second illumination member 15 is arranged to illuminate the joint from the other side of the joint line 8. The welding device 1 is arranged to, with the same camera 16 as used for registering line images, also register a first stereo image when the joint is illuminated with the first illumination member 14 and a second image when the joint is illuminated with the second illumination member 15. The camera is provided with an interference filter 18 which is arranged for transmission of the light from the first illumination member and the second illumination member. The interference filter 18 filters out undesired light which does not originate from the illumination members 14, 15.

The first illumination member 14 illuminates along a first principle illumination direction 21 and the second illumination member 15 illuminates along a second principle illumination direction 22. The angle between the illumination directions for the first illumination member 14 and the second illumination member 15 is greater than 90°.

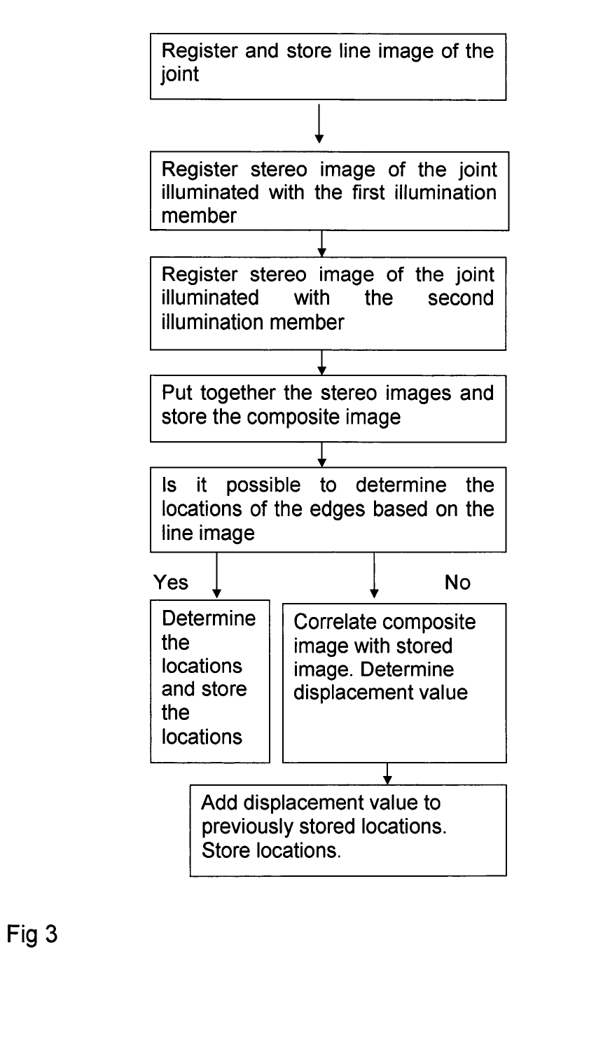

The function of the welding device according to aspects of the invention will now be described with reference to FIG. 3 which is a flow chart and FIG. 1 and FIG. 2. In a first step, the joint is illuminated with a light beam in that the laser beam from the line illumination member 10 is scanned across the joint line 8. A line image of the joint is registered at a plurality of positions along the joint line 8 when it is illuminated with the scanned light beam as is clear from the second step in FIG. 3. Photometric stereo images of the joint are registered at said plurality of positions along the joint line 8 substantially simultaneously with the registration of the line images with the scanned light beam. The positions for the registration of the stereo images and line images are determined and the stereo images and the locations of the edges of the joint are stored in the processing member together with the positions for their registration.

The location of the edges of the joint is determined if possible by means of triangulation based on the registered line image. When registering a stereo image in a position where a stereo image previously has been registered, the registered stereo image is correlated with the previously stored stereo image for the position in order to obtain a displacement value which describes how much the joint has been moved across the joint line in relation to the previously stored stereo image. If it is not possible to determine the location of the edges of the joint by means of triangulation based on the registered line image, the displacement value is added to the previously stored positions. In the beginning of the welding, when the first weld beads are applied in the joint, it is easy to determine the locations of the edges of the joint by triangulation based on the line images. As the joint is being filled, it becomes more and more difficult to determine the locations of the edges of the joint based on the line images. The stereo images are then used instead. Information of where the previous weld bead was applied is used at the correlation of a registered stereo image with a previously stored image.

The location of the welding head in relation to the camera is known. The welding head is controlled in dependence on the location of the edges. During welding of a weld joint with a plurality of weld beads, the welding head is thus controlled in dependence on both stereo images and said data for the shape of the joint.

The above described embodiments may be varied in many different manners without departing from the spirit and scope of the invention which is only limited by the appended claims.

It is of course possible to use more than two images for the registration of the photometric stereo image.

The invention can be applied for joints with a varying width along the joint line, and/or with varying sheet thickness along the joint line.

What is claimed is:

1.-15. (canceled)

16. A welding device for automatic multiple-bead welding of a joint that is formed by two joint surfaces, which joint extends along a joint line and which comprises a first edge on one side of the joint line and a second edge on the other side of the joint line, which edges define the extension of the joint across the joint line, the welding device comprising; a welding head for the application of weld beads in the joint, a line illumination member operable to illuminate the joint by scanning a light beam across the joint line, at least one camera arranged for registering line images of the joint when it is illuminated with the scanned light beam, and a processing member for determining at least the location of the edges of the joint by means of triangulation based on the registered line image, a stereo image member operable to register photometric stereo images of the joint substantially simultaneously with the registration of the line images, wherein the welding device is arranged to, during welding of a weld joint with a plurality of weld beads, control the welding head in dependence on both stereo images and line images.

17. A welding device according to claim 16, wherein the stereo image member comprises a first illumination member and a second illumination member, the first illumination member being operable to illuminate the joint from one side of the joint line and the second illumination member being operable to illuminate the joint from the other side of the joint line, and wherein the welding device is operable to, with said at least one camera register a first stereo image when the joint is illuminated with the first illumination member and a second image when the joint is illuminated with the second illumination member.

18. A welding device according to claim 17, wherein the first illumination member and the second illumination member substantially illuminate along one illumination direction each, wherein the angle between the illumination directions for the first illumination member and the second illumination member is greater than about 90°.

19. A welding device according to claim 16, wherein the camera which is operable to register stereo images also is operable to register line images.

20. A welding device according to claim 16, further comprising a position determination member for determining the positions for the registration of the stereo images and the line images, wherein the stereo images are stored in the processing member together with the position for their registration.

21. A welding device according to claim 20, wherein the processing member is operable to, when registering a stereo image in a position where a stereo image previously has been registered, correlate the registered stereo image with the previously stored stereo image for the position in order to obtain a displacement value which describes how much the joint has been moved across the joint line in relation to the previously stored image.

22. A welding device according to claim 21, wherein the processing member is operable to, when registering a line image in a position, in which a line image has been registered previously, replace the previously stored locations of the edges of the joint by locations which are determined from the registered line image if such a determination is possible and to otherwise add the displacement value to the previously stored locations of the edges of the joint.

23. A welding device according to claim 21, wherein the processing member is operable to use information of where the previous weld bead was applied at the correlation of the registered stereo image with the previously stored stereo image.

24. A welding device according to claim 16, wherein the line illumination member comprises a laser.

25. A welding device according to claim 16, wherein said at least one camera is provided with an interference filter which is arranged for transmission of the light from the first illumination member and the second illumination member.

26. A method for controlling multiple-bead welding of a joint formed by two joint surfaces which joint extends along a joint line and which comprises a first edge on one side of the joint line and a second edge on the other side of the joint line, which edges define the extension of the joint across the joint line, which method comprises the steps of:
illuminating the joint with a light beam by scanning the light beam across the joint line,
registering a line image of the joint at a plurality of positions along the joint line when it is illuminated with the scanned light beam;
determining at least the location of the edges of the joint by means of triangulation based on the registered line image;
registering photometric stereo images of the joint at said plurality of positions along the joint line substantially simultaneously with the registration of the line images with the scanned light beam; and
controlling, during welding of a weld joint with a plurality of weld beads, the welding head in dependence on both stereo images and said data for the shape of the joint.

27. A method according to claim 26, comprising the further steps of:
determining the positions for the registration of the stereo images and the line images; and
storing the stereo images and said locations of the edges of the joint in the processing member together with the position for their registration.

28. A method according to claim 27, further comprising the step of:
when registering a stereo image in a position where a stereo image previously has been registered, correlating the registered stereo image with the previously stored stereo image for the position in order to obtain a displacement value which describes how much the joint has been moved across the joint line in relation to the previously stored stereo image.

29. A method according to claim 28, further comprising the step of:
when registering a line image in a position, in which a line image has been registered previously, replacing the previously stored locations of the edges of the joint with locations which are determined from the registered line image if such a determination is possible and to otherwise add the displacement value to the previously stored positions.

30. A method according to claim 28, wherein the information about where the previous weld bead was applied is used at the correlation of a registered stereo image with a previously stored stereo image.
